(19) United States
(12) Patent Application Publication
(10) Pub. No.: US 2010/0045441 A1
(43) Pub. Date: Feb. 25, 2010

(54) NEAR FIELD COMMUNICATION (NFC) ACTIVATION

(75) Inventors: Olaf Hirsch, Sunnyvale, CA (US); Javier Del Prado, Antibes (FR); Dominique Everaere, Antibes (FR)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/514,641

(22) PCT Filed: Nov. 15, 2007
(86) PCT No.: PCT/IB2007/054661

§ 371 Date: May 13, 2009

Related U.S. Application Data
(60) Provisional application No. 60/859,189, filed on Nov. 15, 2006.

(51) Int. Cl. H04B 5/00; H04Q 5/22

(52) U.S. Cl. 340/10.1; 455/41.1

(57) ABSTRACT

The present invention discloses a method and a system for activating a communication device in presence of a field generated by a near field communication (NFC) tag reader in a near field communication (NFC) environment. The presence of a field generated by a NFC tag reader is automatically detected using detection circuits. Once the field is detected, the presence of the field is signaled to the communication devices associated with the NFC environment. The communication devices are then switched automatically to an appropriate mode according to the field. The method and system of the present invention removes the additional user interaction in pairing various communication devices in the NFC environment.

The present invention generally relates to near field communication (NFC), and more specifically relates to the systems which needs activation in the presence of NFC devices.

Near field communication plays a vital role in today's communication world where consumers are seeking easier ways to interact with the immediate environment and to enable communication between their electronic devices. Delivering convenient wireless connectivity, NFC's intuitive operation changes the way we interact with technology, ensuring the most of the environment and reap the full benefits of total connectivity. NFC is a standards-based, short-range wireless connectivity technology that enables simple and safe two-way interactions among electronic devices, allowing users to perform contact-less transactions, access digital content and connect devices with a single touch. NFC uses electromagnetic waves in radio frequency range and transmits the information content over a short distance (a few centimeters). An example for NFC is an intelligent card reader which is capable of carrying and transmitting information from a storage means to an intelligent device or card reader.

NFC devices use radio frequency identification (RFID) tags to exchange information, and especially in personal area networks (PAN's) to identify one device to another. NFC or RFID tags are being collocated with Bluetooth devices to facilitate NFC supported “simple pairing”. For example, NFC circuits help in the pairing of a Bluetooth headset with the mobile phone. Under normal circumstances it is not possible for the Bluetooth device to find out whether the collocated RFID tag is being read. If NFC is used to support the pairing procedure of a Bluetooth headset, the headset has to be put in pairing mode first before it can be paired. Often this is done by a long button press by the user. The additional user interaction removes some of the advantages to use RFID tags for the pairing procedure.

What is needed then is a mechanism to detect the NFC or RFID reader fields and switch the communication devices using RFID or NFC to appropriate modes. The present invention has been developed to meet these needs in the art.

The present invention discloses a method and a system for activating a communication device in presence of a field generated by a near field communication (NFC) tag reader in a near field communication (NFC) environment. The presence of a field generated by a NFC tag reader is detected using detection circuits. Once the field is detected, the presence of the field is signaled to the communication devices associated with the NFC environment. The communication devices are then switched automatically to an appropriate mode according to the field. The method and system of the present invention removes the additional user interaction in pairing various communication devices in the NFC environment.

In an example embodiment of the present invention a method for activating a communication device in the presence of a field generated by a near field communication tag reader in a near field communication environment (NFC) is provided. The method includes the steps of detecting the presence of the field generated by the NFC tag reader, signaling the presence of the field to the communication device if the field is detected, and switching the communication device automatically to an appropriate mode according to the field generated by the NFC tag reader. The present invention automatically performs detecting, signaling and switching steps without any additional user interaction. Detecting the presence of the field includes building a resonant circuit for generating an alternate voltage in the presence of the field generated, and rectifying and averaging the alternate voltage. The resonant circuit includes an inductor and a variable capacitor coupled in parallel. The alternate voltage is rectified using a diode and averaged using a capacitor. A Zener diode in the detection circuit limits the output voltage for protecting a receiving circuit.

In another example embodiment of the present invention a system for detecting the presence of a field generated by a NFC tag reader in a near field communication environment is provided. The system includes a resonant circuit for generating an alternate voltage in the presence of the field generated by the NFC tag reader, and a diode for rectifying and a capacitor for averaging the alternate voltage respectively. The system also includes a zener diode which limits the output voltage for protecting a receiving circuit.

The above summary of the present invention is not intended to represent each disclosed embodiment, or every aspect, of the present invention. Other aspects and example embodiments are provided in the figures and the detailed description that follows.

The invention may be more completely understood in consideration of the following detailed description of various embodiments of the invention in connection with the accompanying drawings, in which:

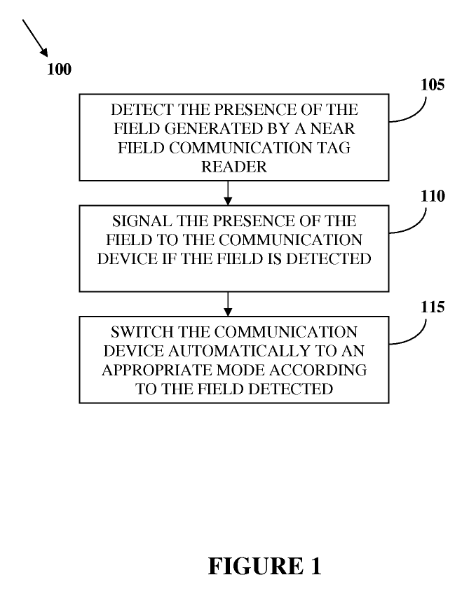

FIG. 1 is a flow diagram illustrating the method of activating a communication device in presence of a field generated by a NFC tag reader.

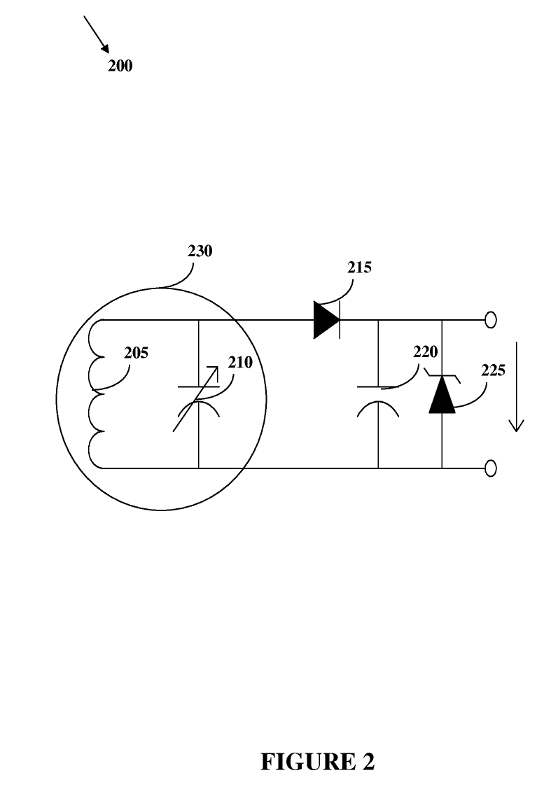

FIG. 2 is a circuit diagram for detecting the presence of field generated by the NFC tag reader according to an embodiment of the present invention.

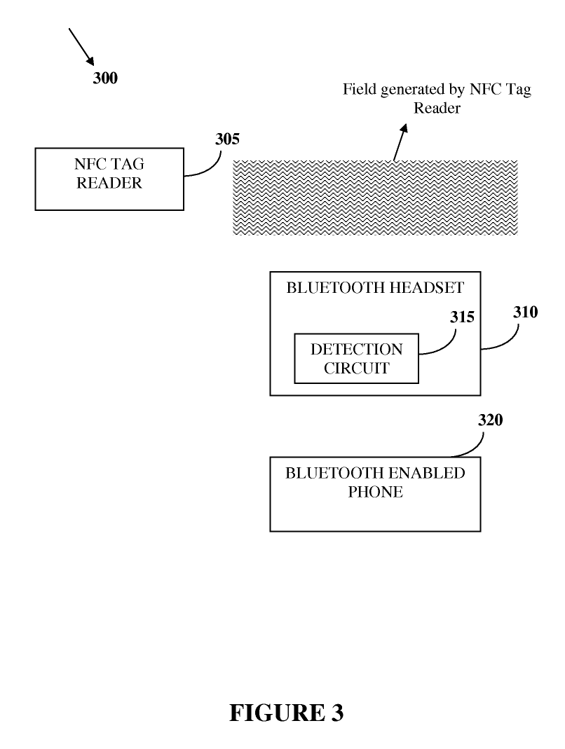

FIG. 3 is a block diagram illustrating the system environment of the method and system of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

FIG. 1 is a flow diagram illustrating the method of activating a communication device in presence of a field generated by a NFC tag reader 100. A step 105, detects the presence of a field generated by a NFC or RFID tag reader. An example of a detection circuit is explained in FIG. 2. If the field is detected, a step 110 indicates the presence of the field to the associated communication devices. Another step 115 switches the communication devices into appropriate modes according to the field generated by the NFC or RFID tag readers.

Considering an example of a Bluetooth headset associated with a Bluetooth enabled mobile phone, NFC circuits help in pairing procedure of Bluetooth headset and the mobile phone. The Bluetooth headset needs to be put in to a special mode to set up the initial bonding between the mobile phone and the Bluetooth headset. The method of the present invention automatically detects and signals the field presence to the Bluetooth headset which will then be able to switch on the pairing mode. This removes the additional user interaction to switch the Bluetooth headset manually (by a long button press as in the art).

FIG. 2 is a circuit diagram for detecting the presence of field generated by the NFC tag reader according to an embodiment of the present invention 200. The circuit includes an inductor 205, a variable capacitor 210, a diode 215, a capacitor 220 and a Zener diode 225. The inductor 205 and variable capacitor 210 builds a resonant circuit 230 which generates an alternate voltage in the presence of an oscillating magnetic field. The variable capacitor 210 value is set such that the resonant circuit 230 has the same frequency as the field generated by the NFC tag reader. The diode 215 rectifies the alternate voltage and the following capacitor 220 averages it. The Zener diode 225 limits the output voltage so that the receiving circuit such as a Bluetooth device does not get damaged. This circuit may be placed in the Bluetooth devices along with the NFC or RFID circuits, which need to be switched to the appropriate modes for pairing. The aforementioned circuit diagram is one of the examples of a detection circuit. Various other detection circuits can be used to detect the presence of the field according to the method of the present invention.

FIG. 3 is a block diagram illustrating the system environment of the method and system of the present invention 300. The figure includes a NFC tag reader 305, Bluetooth headset 310, and a Bluetooth enabled phone 320. The detection circuit 315 as explained in FIG. 2 is placed in the Bluetooth headset 310. The NFC tag reader 305 generates a field. The detection circuit 315 automatically detects and signals the field presence to the Bluetooth headset which will then be able to switch on the pairing mode.

The present invention will find its industrial applications in Bluetooth devices and also in applications other than Bluetooth where a device collocated to a RFID tag needs to be informed about the presence of a magnetic field generated by an NFC reader. The collocated device can then take appropriate actions according to the field detected.

While the present invention has been described with reference to several particular example embodiments, those skilled in the art will recognize that many changes may be made thereto without departing from the spirit and scope of the present invention, which is set forth in the following claims.

1. A method for activating a communication device in presence of a field generated by a near field communication tag reader in a near field communication environment comprising the steps of: detecting said presence of the field generated by said near field communication tag reader automatically; signaling the presence of the field to said communication device if the field is detected; and switching the communication device automatically to an appropriate mode according to the field detected in the detecting step.

2. The method of claim 1, wherein said detecting the presence of the field comprises: building a resonant circuit for generating an alternate voltage in the presence of the field generated by the; and rectifying and averaging said alternate voltage.

3. The method of claim 2, wherein said resonant circuit comprises an inductor and a variable capacitor coupled in parallel.

4. The method of claim 2, wherein the alternate voltage is rectified using a diode and averaged using a capacitor.

5. The method of claim 2 further comprises limiting the output voltage for protecting a receiving circuit using a Zener diode.

6. The method of claim 2 further comprises setting the frequency of the resonant circuit equal to the frequency of said magnetic field using said variable capacitor.

7. The method of claim 1, wherein the steps of detecting, signaling and switching are performed without user interaction, whereby the user interaction for activating the communication device is eliminated.

8. The method of claim 1, wherein said communication device comprises a Bluetooth device.

9. A system for detecting the presence of a field generated by a near field communication tag reader in a near field communication environment comprising: a resonant circuit for generating an alternate voltage in the presence of said field generated by said near field communication tag reader; and a diode for rectifying and a capacitor for averaging said alternate voltage respectively.

10. The system of claim 9 further comprises: a Zener diode for limiting the output voltage of the system to a receiving circuit.

11. The system of claim 9, wherein said resonant circuit comprises: an inductor and a variable capacitor coupled in parallel, the value of said variable capacitor is set such that the resonant circuit has the same frequency as the field generated by said near field communication tag reader.
